(19) United States
(12) Patent Application Publication
(10) Pub. No.: US 2026/0334580 A1
(43) Pub. Date: Oct. 29, 2026

(54) AEROSOL-GENERATING DEVICE AND METHOD FOR PROTECTING AEROSOL-GENERATING DEVICE BY USING DROP DETECTION

(71) Applicant: KT&G CORPORATION, Daejeon (KR)

(72) Inventors: Ju Eon PARK, Gyeonggi-do (KR); Tae Hun KIM, Gyeonggi-do (KR); Youn Ji SHIN, Seoul (KR); Hun Il LIM, Seoul (KR); Hyung Jin JUNG, Seoul (KR)

(73) Assignee: KT&G CORPORATION, Daejeon (KR)

(21) Appl. No.: 19/118,285

(22) PCT Filed: Jul. 25, 2024
(86) PCT No.: PCT/KR2024/010796

§ 371 Date: Apr. 3, 2025

(30) Foreign Application Priority Data
Jul. 31, 2023 (KR) 10-2023-0099863
Nov. 16, 2023 (KR) 10-2023-0159282

(51) Int. Cl. A24F 40/53; A24F 40/20; A24F 40/51; A24F 40/57; A24F 40/85

(52) U.S. Cl. CPC A24F 40/53; A24F 40/85; A24F 40/20; A24F 40/51; A24F 40/57

(57) ABSTRACT

Provided are an aerosol-generating device and a method of protecting the aerosol-generating device by using drop detection, the method including detecting a vertical acceleration of the aerosol-generating device, determining whether the aerosol-generating device has entered a predetermined drop state by monitoring a change in the detected vertical acceleration, and when it is determined that the aerosol-generating device has entered the predetermined drop state, performing a protection process to preserve system data for controlling a heating function of a heater of the aerosol-generating device before a removable battery provided in the aerosol-generating device is detached due to an impact.

### TECHNICAL FIELD

The present disclosure relates to an aerosol-generating device and a method of protecting the aerosol-generating device by using drop detection.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

Meanwhile, as interest in environmental issues increases worldwide, there is a growing demand for proof of environmental friendliness and safety throughout the entire life cycle of batteries, from production to recycling. Accordingly, research on detachable batteries is being conducted in the electronic cigarette field while promoting the development of related technologies such as battery reuse and recycling.

### DISCLOSURE OF INVENTION

### Technical Problem

When an aerosol-generating device is provided with a removable battery, the removable battery may be unintentionally separated due to an external impact. In this case, abnormal separation of the removable battery may shorten the life of the aerosol-generating device or cause a malfunction, thereby making it impossible to ensure the safety of use of the aerosol-generating device. Therefore, a method of protecting a system of the aerosol-generating device before the removable battery is abnormally separated due to an impact is required.

The technical problems of the disclosure are not limited to the aforementioned description, and other technical problems may be derived from the embodiments described hereinafter.

### Solution to Problem

According to the present disclosure, provided is a method of protecting a system function of an aerosol-generating device before an impact occurs by predicting cases in which impacts may occur, thereby preventing safety impairment of the aerosol-generating device and device malfunction caused by abnormal separation of a removable battery.

According to an aspect, an aerosol-generating device includes a motion detector configured to detect a vertical acceleration of the aerosol-generating device, and a processor configured to determine whether the aerosol-generating device has entered a predetermined drop state by monitoring a change in the detected vertical acceleration, wherein the processor is further configured to, when it is determined that the aerosol-generating device has entered the predetermined drop state, perform a protection process to preserve system data for controlling a heating function of a heater of the aerosol-generating device before a removable battery provided in the aerosol-generating device is detached due to an impact.

According to another aspect, a method of protecting an aerosol-generating device by using drop detection includes detecting a vertical acceleration of the aerosol-generating device by using a motion detector, determining, by using a processor, whether the aerosol-generating device has entered a predetermined drop state by monitoring a change in the detected vertical acceleration, and, when it is determined that the aerosol-generating device has entered the predetermined drop state, performing, by using the processor, a protection process to preserve system data for controlling a heating function of a heater of the aerosol-generating device before a removable battery provided in the aerosol-generating device is detached due to an impact.

### Advantageous Effects of Invention

According to the above, by preserving system data through performing a protection process to prevent a failure of an aerosol-generating device, the failure which may be caused by situations such as dropping of or an impact on the aerosol-generating device, it is possible to ensure safe use of the device.

### BRIEF DESCRIPTION OF DRAWINGS

FIG. 1 is a block diagram showing hardware components of an aerosol-generating device, according to an embodiment.

FIGS. 2A to 2E are diagrams illustrating embodiments of the aerosol-generating device of FIG. 1 implemented in various types.

FIG. 3 is a diagram illustrating mounting a new removable battery on an aerosol-generating device according to an embodiment.

FIG. 4 is a diagram for explaining changes in vertical acceleration of an aerosol-generating device, according to an embodiment, as a user carrying the aerosol-generating device walks.

FIG. 5 is a diagram for explaining a state in which an aerosol-generating device according to an embodiment is being dropped.

FIG. 6 is a diagram for explaining drop detection of an aerosol-generating device according to an embodiment.

FIG. 7 is a detailed flowchart of a method of protecting an aerosol-generating device through drop detection according to an embodiment.

FIG. 8 is a diagram for explaining performance of a protection process upon detecting dropping of an aerosol-generating device according to an embodiment.

FIG. 9 is a diagram for explaining performance of a protection process by impact detection according to an embodiment.

FIG. 10 is a detailed flowchart of a method of protecting an aerosol-generating device through impact detection according to an embodiment.

FIG. 11 is a diagram for explaining an impact history of impacts occurred in an aerosol-generating device according to an embodiment.

FIG. 12 is a flowchart of a method of protecting an aerosol-generating device through drop detection according to an embodiment.

### BEST MODE FOR CARRYING OUT THE INVENTION

According to an embodiment, an aerosol-generating device includes a motion detector configured to detect a vertical acceleration of the aerosol-generating device, and a processor configured to determine whether the aerosol-generating device has entered a predetermined drop state by monitoring a change in the detected vertical acceleration, wherein the processor is further configured to, when it is determined that the aerosol-generating device has entered the predetermined drop state, perform a protection process to preserve system data for controlling a heating function of a heater of the aerosol-generating device before a removable battery provided in the aerosol-generating device is detached due to an impact.

### Mode for the Invention

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

Hereinafter, the embodiments will now be described more fully with reference to the accompanying drawings, in which exemplary embodiments are shown such that one of ordinary skill in the art may easily work the embodiments. The embodiments can, however, be embodied in many different forms and should not be construed as being limited to the embodiments set forth herein.

Hereinafter, embodiments will be described in detail with reference to the drawings.

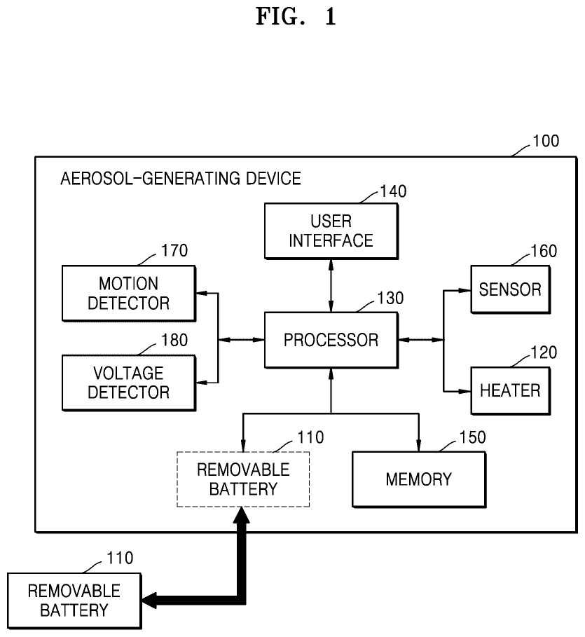

FIG. 1 is a block diagram showing hardware components of an aerosol-generating device, according to an embodiment.

Referring to FIG. 1, the aerosol-generating device 100 may include a removable battery 110, a heater 120, a processor 130, a user interface 140, a memory 150, a sensor 160, a motion detector 170, and a voltage detector 180. However, the hardware components inside the aerosol-generating device 100 are not limited to those shown in FIG. 1. Those skilled in the art relating to the present embodiment may understand that some of the hardware components shown in FIG. 1 may be omitted or a new component (e.g., a communication module, etc.) may be added to FIG. 1 according to the design of the aerosol-generating device 100.

Hereinafter, an operation of each of the components will be described without being limited to a space in which each of the components in the aerosol-generating device 100 is positioned.

The removable battery 110 may supply power to be used for operating the aerosol-generating device 100. For example, the removable battery 110 may supply power to the heater 120 for heating the heater. In addition, the removable battery 110 may continuously supply power for acceleration monitoring of the motion detector 170 even when the aerosol-generating device 100 is not in use. That is, the removable battery 110 may supply power required for the operation of other hardware components provided in the aerosol-generating device 100, such as the heater 120, the processor 130, the user interface 140, the memory 150, the sensor 160, or the motion detector 170. The removable battery 110 may be, for example, a lithium polymer (LiPoly) battery or a lithium ion battery, but is not limited thereto.

The removable battery 110 is a replaceable type (separate) power source and may be mounted in a battery accommodation unit provided in the aerosol-generating device 100 or removed from the battery accommodation unit. The removable battery 110 is provided with an electric contact, and when the removable battery 110 is mounted on the aerosol-generating device 100, the electric contact of the removable battery 110 may be electrically connected to the electric contact of a battery connection provided in the aerosol-generating device 100 to provide battery-related data or supply power to the aerosol-generating device 100. In another example, the removable battery 110 may be provided with a charging coil (transmission/reception coil), instead of a separate electric contact, for supplying power to the aerosol-generating device 100 through a wireless charging method and in this case, the battery connection may be implemented as a transmission/reception coil. That is, power supply methods of the removable battery 110 may vary, and electrical connection methods between the removable battery 110 and the battery connection of the aerosol-generating device 100 may vary according to the power supply method supported by the removable battery 110.

The removable battery 110 may be provided with a charger interface (not shown) that may be connected to an external charger. Power for charging the removable battery 110 may be supplied to the removable battery 110 via the charger interface. The removable battery 110 may be charged by an external charger while being attached to the aerosol-generating device 100 or uninstalled from the aerosol-generating device 100.

The removable battery 110 may be optionally provided with a wireless tag such as a radio frequency identification (RFID) tag, a near field communication (NFC) tag, etc. The wireless tag provided in the removable battery 110 may be read through a protocol for short-range communication with a wireless module such as an RFID module or an NFC module. When a wireless tag is provided in the removable battery 110, identification information related to the removable battery 110, battery capacity information, etc. may be recorded in the wireless tag. In this case, the aerosol-generating device 100 may obtain various information of the removable battery 110 by tagging the wireless tag of the removable battery 110.

The heater 120 may receive power from the removable battery 110 under the control of the processor 130. The heater 120 may perform a heating function of heating a cigarette inserted into the aerosol-generating device 100 or heating a cartridge mounted on the aerosol-generating device 100 by using power supplied from the removable battery 110. That is, the heater 120 may generate an aerosol by heating an aerosol-generating material provided in a cigarette or cartridge.

The heater 120 may be provided in a body of the aerosol-generating device 100. Alternatively, when the aerosol-generating device 100 consists of the body and the cartridge, the heater 120 may be provided in the cartridge. When the heater 120 is provided in the cartridge, the heater 120 may receive power from the removable battery 110 included in the body.

The heater 120 may be implemented as an electric resistance heating-type heater formed of an electric resistance material. For example, the electric resistance material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. The heater 120 may be implemented as a metal heating wire, a metal heating plate on which an electrically conductive track is arranged, or a ceramic heating element, but is not limited thereto.

The heater 120 may be implemented as an induction heating heater. The heater 120 may correspond to a heater assembly implemented as a set of electrically conductive coils and susceptors for heating a cigarette or cartridge by induction heating.

The heater 120 may heat a cigarette inserted into an accommodation space provided in the aerosol-generating device 100. As the cigarette is accommodated in the accommodation space of the aerosol-generating device 100, the heater 120 may be positioned inside and/or outside the cigarette. Accordingly, the heater 120 may generate aerosol by heating the aerosol-generating material in the cigarette.

The heater 120 may be implemented as a coil heater provided only in the cartridge. The cartridge may include a coil heater, a liquid delivery means, and a liquid storage, an aerosol-generating material accommodated in the liquid storage may be delivered through a liquid delivery element, and an aerosol may be generated by the coil heater by heating the aerosol-generating material absorbed in the liquid delivery element. For example, when the heater 120 is a coil heater, the heater 120 may be formed with a material such as nickel chromium and may be wound around or arranged adjacent to the liquid delivery element.

The processor 130 may control general operations of the aerosol-generating device 100. The processor 130 may include at least one processing unit, such as a micro controller unit (MCU). The processor 130 may be implemented as an array of a plurality of logic gates or may be implemented as a combination of a general-purpose microprocessor and a memory in which a program executable in the microprocessor is stored. In addition, those skilled in the art related to the present embodiment may understand that the processor may consist of another type of hardware.

The processor 130 may analyze a result of sensing by the sensor 160 or a result of detecting by the motion detector 170 and control processes to be performed subsequently based on the analyzed results. For example, the processor 130 may control power supplied to the heater 120 to start or end an operation of the heater 120 based on a result of sensing by the sensor 160. In addition, based on the result of sensing by the sensor 160, the processor 130 may control the amount of power supplied to the heater 120 and the time when the power is supplied such that the heater 420 is heated to a predetermined temperature or maintained at an appropriate temperature. Alternatively, the processor 130 may perform drop detection (or fall detection) of the aerosol-generating device 100 based on the result detected by the motion detector 170.

The processor 130 may control the operation of the heater 120 based on a pre-stored temperature profile. Additionally, the processor 130 may sense a user's puff by using a puff sensor in the sensor 160 to control the temperature of the heater 120. In addition, the processor 130 may count the number of puffs with the puff sensor and stop supplying power to the heater 120 when the number of puffs reaches a preset number.

The processor 130 may also control the user interface 140 based on the sensing result. For example, when the number of puffs reaches a preset number after counting the number of puffs with the puff sensor, the processor 130 may notify the user that the aerosol-generating device 100 will end soon with a lamp, a motor, or a speaker.

Meanwhile, the processor 130 may recognize or detect that the removable battery 110 has been detached or mounted through the voltage detector 180. Additionally, the processor 130 may monitor whether the removable battery 110 is normally connected based on a voltage detected by the voltage detector 180.

The user interface 140 may provide the user with information about the state of the aerosol-generating device 100. The user interface 140 may include various interfacing elements, such as a display or lamp that outputs visual information (a user interface screen), a motor that outputs tactile information, a speaker that outputs sound information, input/output (I/O) interfacing elements (e.g., a button or a touch screen) that receive information input from the user or output information to a user, and terminals for receiving charging power.

The memory 150 may be a hardware component configured to store various pieces of data processed in the aerosol-generating device 100, and the memory 150 may store data processed or to be processed by the processor 130. The memory 150 includes various memory devices, for example, random access memory (RAM) such as dynamic random access memory (DRAM) or static random access memory (SRAM), read-only memory (ROM), electrically erasable programmable read-only memory (EEPROM), and so on.

The memory 150 may store data necessary for controlling the heating operation of the heater 120, such as the operation time of the aerosol-generating device 100, the maximum number of puffs, the temperature profile, etc., and various usage data stored while the aerosol-generating device 100 is in use, such as the user's smoking information and information for battery authentication.

The memory 150 may also store backup and restore data for performing backup process and restoring process to maintain various pieces of data in the aerosol-generating device 100 before and after battery replacement in the replacement process of the removable battery 110. Additionally, the memory 150 may store backup and restore data to prevent data loss due to abnormal separation of the removable battery 110.

The sensor 160 may include a puff sensor. The puff sensor may detect a puff of a user based on at least one of a change in a flow rate of an externally introduced airflow, a change in pressure, and detection of sound. The processor 130 may count the number of puffs by detecting the start and end times of the user's puffs by using a puff sensor.

The sensor 160 may include a user input sensor. The user input sensor may be a sensor capable of receiving a user's input, such as a switch, a physical button, or a touch sensor.

The sensor 160 may include a cigarette detection sensor that may detect whether a cigarette has been inserted or removed. The cigarette detection sensor may refer to a sensor, such as an inductance sensor, a capacitance sensor, an infrared sensor, a color sensor, etc., which detect the presence or absence of a cigarette without mechanical contact by measuring changes in electrical signals resulting from interaction with the cigarette.

The sensor 160 may include various sensors for measuring information of the surrounding environment of the aerosol-generating device 100. For example, the sensor 160 may include a temperature sensor for measuring the temperature of the surrounding environment, a humidity sensor for measuring the humidity of the surrounding environment, a moisture sensor detecting leakage or submersion of the aerosol-generating device 100, an atmospheric pressure sensor for measuring the pressure of the surrounding environment, etc.

The sensor 160 that may be provided in the aerosol-generating device 10 is not limited to the sensors described above and may further include various sensors. For example, the aerosol-generating device 100 may include a fingerprint sensor for acquiring fingerprint information from a user's finger for user authentication and security, an iris recognition sensor for analyzing an iris pattern of the pupil, a vein recognition sensor for detecting the amount of infrared absorption of reduced hemoglobin in vein from an image obtained by capturing the palm, a facial recognition sensor for recognizing feature points of eyes, a nose, a mouth, a facial contour, and so on through a two-dimensional (2D) or three-dimensional (3D) method, a radio-frequency identification (RFID) sensor, or the like.

The aerosol-generating device 100 may selectively include only some of the examples of the various sensors 160 described above. In other words, the aerosol-generating device 100 may combine and utilize information sensed by at least one sensor of the sensors described above.

When a removable battery 110 is mounted on the aerosol-generating device 100, the voltage detector 180 may detect the voltage applied by the removable battery 110 based on an electrical connection formed through a connector connected to the removable battery 110. For example, the voltage detector 180 may be electrically connected to a protection circuit module (PCM) provided in the removable battery 110 and detect a voltage applied by the removable battery 110.

The aerosol-generating device 100 may be supplied with power from the removable battery 110 or access a protective circuit module of the removable battery 110 through a connector contact (or a connector bond) with the removable battery 110.

The removable battery 110 may be coupled to the aerosol-generating device 100, for example, by being fixed to a battery accommodation unit (not shown) having a hook structure. In another example, the removable battery 110 may be implemented by a method in which a magnetic body in a portion of the removable battery 110 is magnetically coupled to a magnetic body area or an electromagnet area provided in a portion of the battery accommodation unit. That is, the method in which the removable battery 110 according to the present embodiment is mounted on the aerosol-generating device 100 is not limited to one method and may be implemented in various ways.

The motion detector 170 is a hardware component, such as an acceleration sensor, a gyroscope sensor, and an inertial measurement unit (IMU), which acquire data regarding the location and movement of a device. For example, the motion sensor may include an acceleration sensor for measuring accelerations in three directions, which are x-axis, y-axis, and z-axis directions, and a gyro sensor for measuring angular velocity in three directions.

The motion detector 170 may detect acceleration or motion of the aerosol-generating device 100. That is, the motion detector 170 may measure the acceleration or current orientation currently applied to the aerosol-generating device 100. The motion detector 170 may collect motion data continuously or periodically over a certain period of time, or in response to a trigger event. Here, the motion detector 170 may be controlled to collect motion data of a specific direction (e.g., toward the ground surface).

The aerosol-generating device 100 may be carried along with the user, and in this case, the motion detector 170 provided in the aerosol-generating device 100 may continuously or periodically collect motion data (i.e., acceleration) regarding the acceleration of the aerosol-generating device 100. Motion data may be measured at a predetermined sampling frequency and obtained in the form of acceleration changes over time.

The motion detector 170 may detect a vertical acceleration of the aerosol-generating device 100 to perform drop detection (or fall detection) of the aerosol-generating device 100, and the processor 130 may monitor changes in the detected vertical acceleration to determine whether the aerosol-generating device 100 has entered a predetermined drop state (or fall state). Vertical acceleration refers to acceleration in a direction in which gravity is applied to the aerosol-generating device 100.

Particularly, when the vertical acceleration detected by the motion detector 170 is monitored to exceed a threshold acceleration, the processor 130 may determine that the aerosol-generating device 100 has entered a predetermined drop state. Here, the threshold acceleration may be set to a value corresponding to a predetermined ratio (e.g., 80% value, 90% value, 100% value, or the like) of a gravitational acceleration (1 g, approximately 9.8 m/s²), and the predetermined ratio may be variously determined according to design characteristics of the aerosol-generating device 100.

When the detected vertical acceleration exceeds the threshold acceleration, there is a high probability that the aerosol-generating device 100 has been detached from the user and being dropped alone. Accordingly, the processor 130 determines that the aerosol-generating device 100 is in a free drop state when the detected vertical acceleration is monitored to exceed the threshold acceleration.

When the aerosol-generating device 100 is dropped, the removable battery 110 may be unintentionally separated from the aerosol-generating device 100 due to the impact. When such an abnormal separation occurs, the power supply to the removable battery 110 may be momentarily cut off, thereby causing power supply to the hardware components provided in the aerosol-generating device 100 to be interrupted, and thus resulting in a software or hardware failure. In order to prevent such a phenomenon, the aerosol-generating device 100 according to the present embodiment performs drop detection (or fall detection) by the motion detector 170 and performs a process to protect system data of the aerosol-generating device 100 before an impact due to a drop (or a fall) occurs to the aerosol-generating device 100. Accordingly, even when the removable battery 110 is separated due to an impact, the system of the aerosol-generating device 100 may be safely protected.

Although not shown in FIG. 1, the aerosol-generating device 100 may constitute an aerosol-generating system together with a separate cradle. For example, the cradle may be used to store the aerosol-generating device 100 while charging the removable battery 110 of the aerosol-generating device 100. That is, the cradle may be a dedicated device for the aerosol-generating device 100 that receives power from the battery of the cradle and charges the removable battery 110 of the aerosol-generating device 100 while the aerosol-generating device 100 is accommodated in the accommodation space in the cradle.

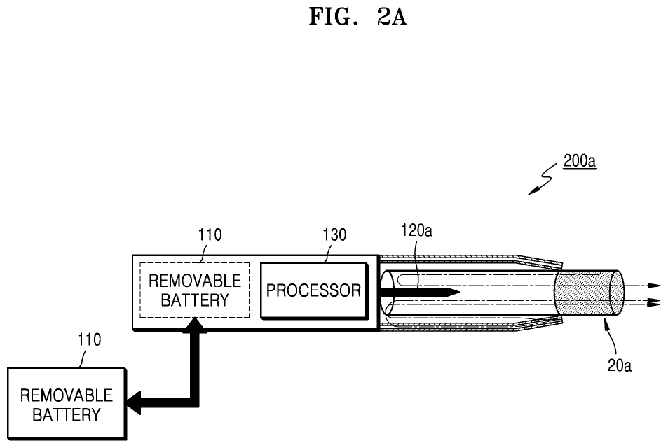

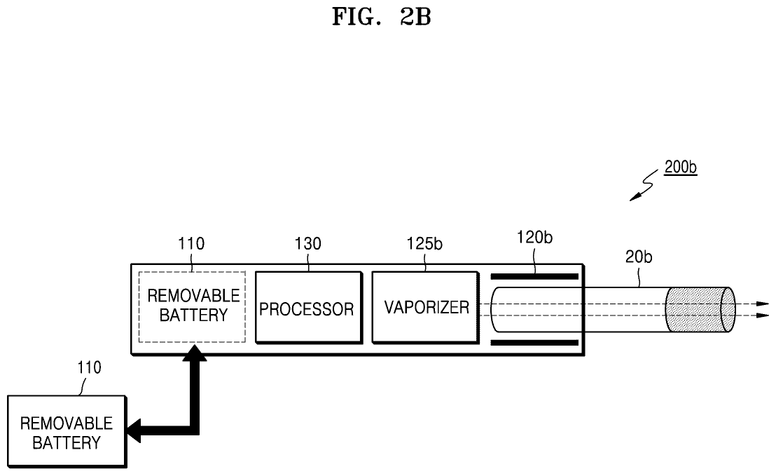

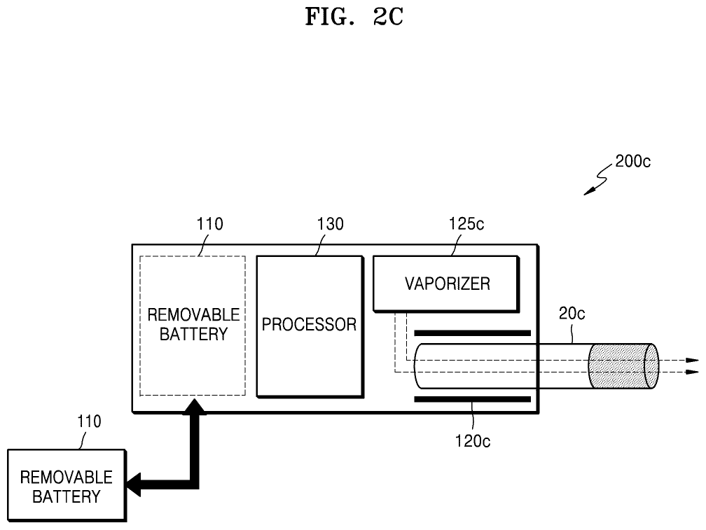

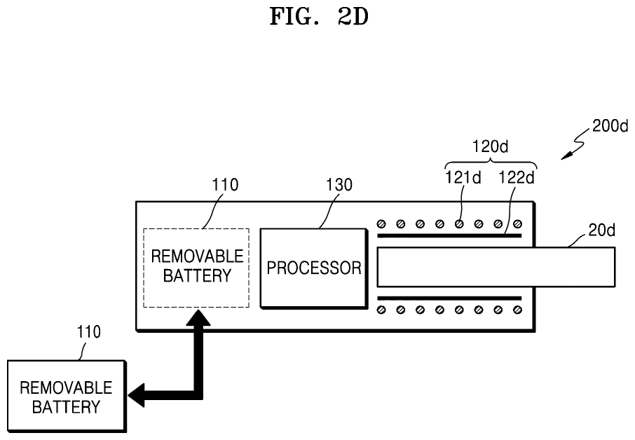

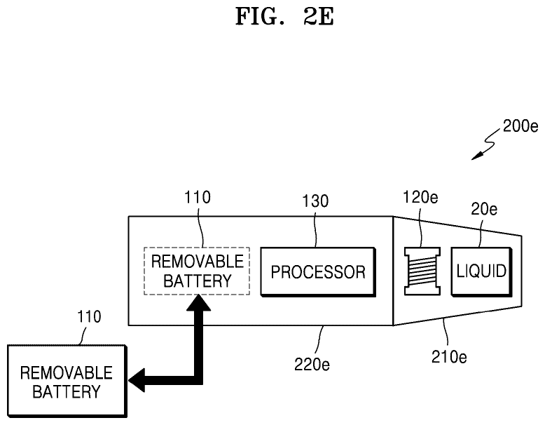

FIGS. 2A to 2E are diagrams illustrating embodiments of the aerosol-generating device of FIG. 1 implemented in various types. Referring to FIGS. 2A to 2E, the aerosol-generating device 100 may be implemented as various types of aerosol-generating devices 200a to 200e, such as those using an electric resistance heating method or an induction heating method, those additionally provided with a vaporizer, and those using a cartridge method. Only some elements for explaining the types of aerosol-generating devices 200a to 200e are illustrated in FIGS. 2A to 2E, and other general elements may be further included in the aerosol-generating devices 200a to 200e in addition to the elements illustrated in FIGS. 2A to 2E.

In FIGS. 2A to 2E, the removable battery 110, heaters 120a to 120e, and the processor 130 are components corresponding to the removable battery 110, the heater 120, and processor 130 of FIG. 1, respectively, and may perform the functions of the removable battery 110, the heater 120, and the processor 130 described above in FIG. 1.

FIG. 2A is a diagram for explaining an aerosol-generating device 200a using electric resistance according to an example embodiment. The aerosol-generating device 200a may be a type of the aerosol-generating device 100.

Referring to FIG. 2A, the aerosol-generating device 200a may include the removable battery 110, the heater 120a, and the processor 130.

A cigarette 20a may be inserted into an accommodation space of the aerosol-generating device 200a. When the cigarette 20a is inserted into the aerosol-generating device 200a, the aerosol-generating device 200a may generate an aerosol from the cigarette 20a by heating the cigarette 20a by using the heater 120a. The generated aerosol passes through the cigarette 20a and is delivered to the user, so the user may smoke the cigarette 20a.

The heater 120a may be heated by the power supplied from the removable battery 110. The heater 120a may be an electric resistance heater. For example, the heater 120a may include an electrically conductive track, and the heater 120a may be heated when currents flow through the electrically conductive track.

The electrically conductive track of the heater 120a may be made of an electric resistance material and a heating temperature of the heater 120a may be determined according to power consumption of resistance, and a resistance value of the electrically conductive track may be set based on the power consumption of resistance of the electrically conductive track. The resistance value of the electrically conductive track may be variously set according to a component material, length, width, thickness, pattern, or the like of the electric resistance material.

The electrically conductive track may have an internal resistance level that increases as the temperature increases according to a resistance temperature coefficient characteristic. For example, in a certain temperature range, the temperature of the electrically conductive track and the magnitude of resistance may be proportional. Using the above principle, the heater 120a made of an electrically conductive track may heat the cigarette 20a by electric resistance.

The electrically conductive track may be made of tungsten, gold, platinum, silver copper, nickel palladium, or a combination thereof. In addition, the electrically conductive track may be doped with a suitable dopant and may include an alloy.

The heater 120a may be manufactured in various shapes, such as a tube shape, a plate shape, a needle shape, or a rod shape. In addition, a plurality of heaters 120a may be arranged. The heater 120a may be inserted into the cigarette 20a and used in an internal heating method to heat the inside of the cigarette 20a.

The removable battery 110 may be separated from or mounted on the aerosol-generating device 200a, and when the removable battery 110 is mounted on the aerosol-generating device 200a, power may be supplied from the removable battery 110 to the heater 120a for the heating operation of the heater 120a, thereby controlling the temperature of the electrically conductive track.

The processor 130 may control the heating operation of the heater 120a by controlling the power supplied to the heater 120a. For example, the processor 130 may control the temperature at which the cigarette 20a is heated by the heater 120a according to the temperature profile.

FIGS. 2B and 2C are diagrams for explaining aerosol-generating devices 200b and 200c additionally provided with vaporizers 125b and 125c according to example embodiments. Each of the aerosol-generating devices 200b and 200c may be a type of the aerosol-generating device 100.

Referring to FIGS. 2B and 2C, the aerosol-generating devices 200b and 200c may further include the vaporizers 125b and 125c. Cigarettes 20b and 20c may be inserted into the aerosol-generating devices 200b and 200c.

FIG. 2B shows that the vaporizer 125b and the heater 120b are arranged in a row. However, FIG. 2C illustrates that the vaporizer 125c and the heater 120c are arranged in parallel. That is, the aerosol-generating devices 200b and 200c may be distinguished according to the arrangement of the vaporizer 125b.

The heaters 120b and 120c may be heated by power supplied from the removable battery 110. The heaters 120b and 120c are electric resistance heaters and may include, for example, electrically conductive tracks.

Unlike the heater 120a described in FIG. 2A, the heaters 120b and 120c of FIGS. 2B and 2C may be implemented as an external heating type by being arranged around the outer circumference of the cigarettes 20b and 20c to heat the outer surface of the cigarettes 20b and 20c.

The vaporizers 125b and 125c may include a liquid storage, a liquid delivery element, and a heating element (or vaporizing element). In other words, the aerosol generated by the vaporizers 125b and 125c may be delivered along an airflow passage of the aerosol-generating devices 200b and 200c and the airflow passage may be configured such that the aerosol generated by the vaporizers 125b and 125c passes through the cigarettes 20b and 29c to be delivered to the user.

The vaporizers 125b and 125c may include a liquid storage, a liquid delivery element, and a heating element (or a vaporizing element). However, the liquid storage, the liquid delivery element, and the heating element may each be an independent module arranged in other locations within the aerosol-generating device 100 rather than within the vaporizers 125b and 125c.

The liquid storage may store a liquid composition. For example, the liquid composition may be a liquid including a tobacco-containing material including a volatile tobacco flavor component or may be a liquid including a non-tobacco material. The liquid storage may be detachable from the vaporizers 125b and 125c or integrally formed with the vaporizers 125b and 125c. For example, the liquid composition may include water, a solvent, ethanol, plant extract, spices, flavorings, or a vitamin mixture. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element provided in the vaporizers 125b and 125c is an element for heating (vaporizing) a liquid composition delivered by a liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may deliver heat to the liquid composition in contact with the heating element, thereby heating the liquid composition. As a result, aerosol may be generated. Accordingly, the vaporizers 125b and 125c may also be referred to by other terms such as cartomizer or atomizer.

The removable battery 110 may be separated from or mounted on the aerosol-generating devices 200b and 200c, and when the removable battery 110 is mounted on the aerosol-generating devices 200b and 200c, power may be supplied from the removable battery 110 to the heaters 120b and 120c and the vaporizers 125b and 125c for the heating operation of the heaters 120b and 120c and the vaporizers 125b and 125c.

The processor 130 may control the heating operation of the heaters 120b and 120c and the vaporizers 125b and 125c by controlling the power supplied to the heaters 120b and 120c and the vaporizers 125b and 125c. For example, the processor 130 may control the temperature at which the cigarettes 20b and 20c are heated by the heaters 120b and 120c and the vaporizers 125b and 125c according to the temperature profile.

FIG. 2D is a diagram for explaining an aerosol-generating device 200d using an induction heating method according to an example embodiment. The aerosol-generating device 200d may be a type of the aerosol-generating device 100.

Referring to FIG. 2D, the aerosol-generating device 200d may include a heater 120d including a coil 121d and a susceptor 122d, the removable battery 110, and the processor 130.

The aerosol-generating device 200d may generate an aerosol by heating a cigarette 20d accommodated in the aerosol-generating device 200d by induction heating. The induction heating method may refer to a method of letting a magnetic substance emit heat by applying, to the magnetic body, which emits heat by using an external magnetic field, an alternating magnetic field, a direction of which is periodically changed. Thus, the aerosol-generating device 200d may emit heat energy from a magnetic body by applying an alternating magnetic field to the magnetic material and may heat the cigarette 20d by transmitting the thermal energy emitted from the magnetic body to the cigarette 20d. Here, the magnetic body that emits heat by an external magnetic field may be the susceptor 122d. The susceptor 122d may be provided in the aerosol-generating device 200d. Alternatively, the susceptor 122d may be provided inside the cigarette 20d in a shape of a piece, a thin piece, a strip, etc. instead of being provided in the aerosol-generating device 200d.

The susceptor 122d may be formed of a ferromagnetic substance. For example, the susceptor 122 may include metal or carbon. The susceptor 122d may include at least one of ferrite, a ferromagnetic alloy, stainless steel, and aluminum (Al). In addition, the material of the susceptor 122d may include at least one of a ceramic such as graphite or zirconia, a transition metal such as nickel (Ni) or cobalt (Co), or a metalloid such as boron (B) or phosphorus (P).

The aerosol-generating device 200d may accommodate a cigarette 20d. A space for accommodating the cigarette 20d may be formed in the aerosol-generating device 200d. A susceptor 122d may be arranged around a circumference of the space accommodating the cigarette 20d. For example, the susceptor 122d may have a cylindrical shape surrounding the outside of the cigarette 20d. Accordingly, when the cigarette 20d is accommodated in the aerosol-generating device 200d, the cigarette 20d may be accommodated in the accommodation space of the susceptor 122d, and the susceptor 122d may be arranged at a position surrounding at least a portion of the outer surface of the cigarette 20d. However, the shape of the susceptor 122d is not limited thereto and may vary.

The heater 120d using an induction heating method may heat the cigarette 20d accommodated in the aerosol-generating device 200d by using the susceptor 122d that emits heat by an external magnetic field generated by the coil 121d.

The coil 121d may be wound along the outer surface of the susceptor 122d, such that an alternating magnetic field is applied to the susceptor 122d. When power is supplied to the coil 121d from the aerosol-generating device 200d, a magnetic field may be formed inside the coil 121d. When an alternating current is applied to the coil 121d, a direction of the magnetic field formed inside the coil 121d may be continuously changed. When the susceptor 122d is positioned inside the coil 121d to be exposed to an alternating magnetic field having a periodically changing direction, the susceptor 122d may emit heat, and the cigarette 20d accommodated in the susceptor 122d may be heated. The coil 121d may have a cylindrical shape wound along the length direction of the cigarette 20d, but is not limited thereto and the coil 121d may be implemented in various types such as a flat coil.

The removable battery 110 may be separated from or mounted on the aerosol-generating device 200d, and when the removable battery 110 is mounted on the aerosol-generating device 220d, power may be supplied to the coil 121d for the heating operation of the heater 120d, for example.

The processor 130 may control the heating operation of the heater 120d by controlling the power supplied to the coil 121d. For example, the processor 130 may control the temperature at which the cigarette 20d is heated by inductive heating of the susceptor 122d by adjusting the strength of the magnetic field induced by the coil 121d according to the temperature profile.

In FIG. 2D, it is assumed that the heater 120d is implemented using an induction heating method using the coil 121d and the susceptor 122d, but as another embodiment, the heater 120d may be implemented as an electric resistance heater (e.g., a cylindrical film heater) as described in FIGS. 2B and 2C to heat the outside of the cigarette 20d. That is, when the heater 120d is manufactured as an electric resistance heater, the aerosol-generating device 200d of FIG. 2D may also be implemented to generate an aerosol from the cigarette 20d using only an electric resistance heater (the heater 120d) without the vaporizers 125b and 125c of FIGS. 2B and 2C.

FIG. 2E is a diagram for explaining an aerosol-generating device 200e having a replaceable cartridge 210e including an aerosol-generating material 20e according to an example embodiment.

Referring to FIG. 2E, the aerosol-generating device 200e includes a cartridge 210e including the aerosol-generating material 20e and a main body 220e that supports the cartridge 210e. The aerosol-generating device 200e may correspond to a type of the aerosol-generating device 100 of FIG. 1. In this case, the hardware components included in the aerosol-generating device 100 of FIG. 1 may be divided to be positioned in the main body 220e and the cartridge 210e.

The cartridge 210e may be coupled to the main body 220e while accommodating an aerosol-generating material therein. The cartridge 210e may be mounted on the main body 210 by inserting a portion of the cartridge 210e into a receptacle of the main body 210.

The cartridge 210e may contain an aerosol-generating material 20e of a liquid composition, but is not limited thereto and may also contain an aerosol-generating material 20e in any one of a solid state, a gaseous state, and a gel state. For example, the liquid composition may be a liquid including a tobacco-containing material including a volatile tobacco flavor component or may be a liquid including a non-tobacco material.

The heater 120e provided in the cartridge 210e performs a heating operation by an electric signal or wireless signal transmitted from the main body 220e. Accordingly, an aerosol may be generated by vaporizing the aerosol-generating material 20e inside the cartridge 210e due to heating by the heater 120e.

The heater 120e may be implemented as a conductive filament made of a metal material such as copper, nickel, or tungsten, or a ceramic heating element, to heat an aerosol-generating material delivered to a liquid delivery element by generating heat through electric resistance, and may be wound around the liquid delivery element or placed adjacent to the liquid delivery element.

The removable battery 110 may be separated from or mounted on the aerosol-generating device 200e, and when the removable battery 110 is mounted on the aerosol-generating device 200e, power may be supplied to the heater 120e from the removable battery 110 for the heating operation of the heater 120e.

The processor 130 may control the heating operation of the heater 120e by controlling the power supplied to the heater 120e. For example, the processor 130 may control the temperature at which the aerosol-generating material 20e is heated by the heater 120e according to the temperature profile.

Although not illustrated in FIGS. 2A to 2E, the aerosol-generating devices 200a to 200e and an additional cradle may form a system. For example, the cradle may store the aerosol-generating devices 200a to 200e or charge the removable battery 110 of the aerosol-generating devices 200a to 200e.

According to various embodiments, the aerosol-generating device 100 of FIG. 1 may be implemented as at least one of the types of the aerosol-generating devices 200a to 200e of FIGS. 2A to 2E, but is not necessarily limited thereto and may be implemented as other types as well.

The aerosol-generating devices 200a to 200e of FIGS. 2A to 2E may commonly use the removable battery 110 as a power source. The removable battery 110 may be replaced by being mounted on or removed from the aerosol-generating devices 200a to 200e.

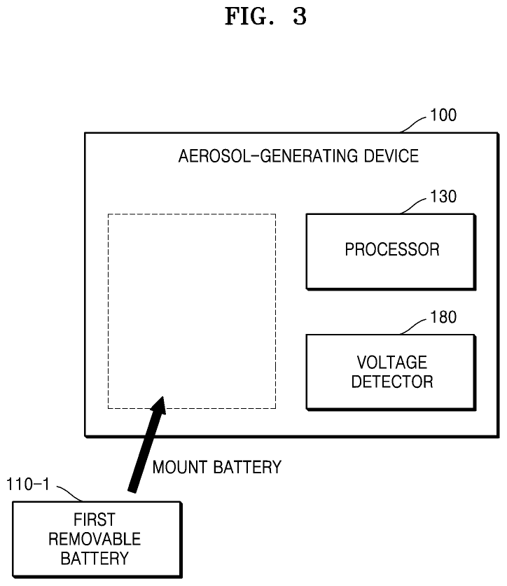

FIG. 3 is a diagram illustrating mounting a new removable battery on an aerosol-generating device according to an embodiment.

Referring to FIG. 3, a battery may not currently be mounted on the aerosol-generating device 100. In the above state, the battery may be removed from the aerosol-generating device 100 because the user wants to replace the battery with a new one, either because of expiration of battery life, because a battery with a different capacity is required by the user, or for other reasons. In this case, the user may wish to mount a first removable battery 110-1 as a new battery in the aerosol-generating device 100.

When the first removable battery 110-1 is mounted on the aerosol-generating device 100 by being fixed to the battery accommodating unit (not shown) of the aerosol-generating device 100, an electrical connection may be formed by a connection between a terminal (a connector) of the removable battery 110 and a terminal (a connector) of the aerosol-generating device 100. The voltage detector 180 may detect the connection or separation of the removable battery 110 by detecting the voltage applied from the removable battery 110 through the terminal (the connector). For example, the voltage detector 180 may detect a voltage of about 3.5 [V] to about 4 [V] when the removable battery 110 is attached, and may detect a voltage of 0 [V] when the removable battery 110 is separated. In this way, the processor 130 may detect the connection or separation of the removable battery 110 by monitoring a voltage change.

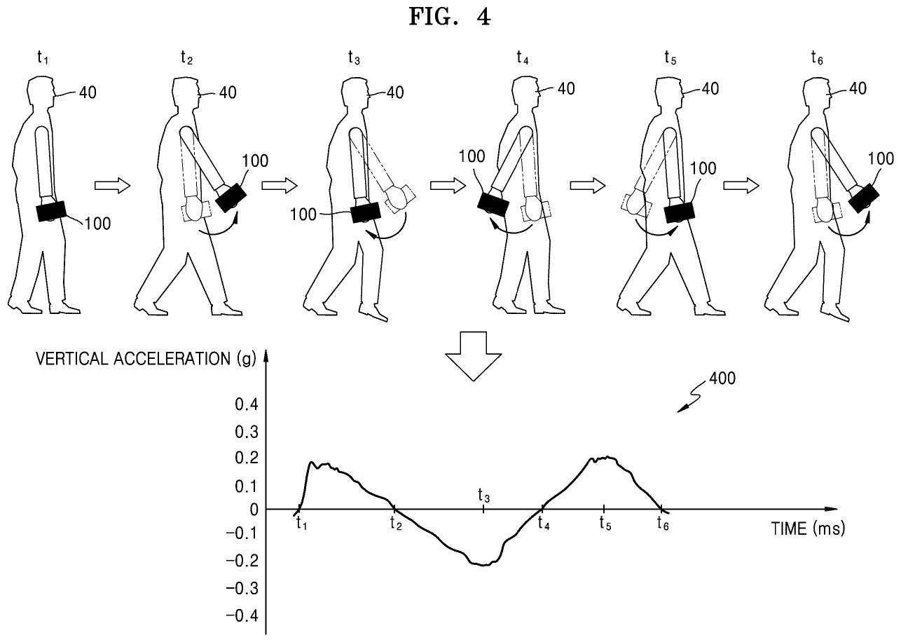

FIG. 4 is a diagram for explaining changes in vertical acceleration of an aerosol-generating device, according to an embodiment, as a user carrying the aerosol-generating device walks.

Referring to FIG. 4, a case in which a user 40 is walking while holding an aerosol-generating device 100 in his hand is illustrated. In addition, at the bottom of FIG. 4, a graph 400 showing a change in a vertical acceleration (g) of the aerosol-generating device 100 according to the walking of the user 40 is shown.

At the time t₁, the user 40 carrying the aerosol-generating device 100 may be in a stationary state. When the user 40 starts walking, the user 40 naturally swings his or her arms back and forth, and accordingly, the aerosol-generating device 100 may perform a pendulum motion. At the time t₂, the aerosol-generating device 100 reaches a highest point in a walking direction and is suspended momentarily. After the time t₂, the aerosol-generating device 100 moves in an opposite direction of the walking direction and reaches a lowest point at the time t₃. At a time t₄, the aerosol-generating device 100 reaches a highest point in an opposite direction of the walking direction and is suspended momentarily. After the time t₄, the aerosol-generating device 100 moves along the walking direction and reaches a lowest point at a time t₅. At a time t₆, the aerosol-generating device 100 reaches a highest point in the walking direction and is suspended momentarily.

That is, while the user 40 is walking, the aerosol-generating device 100 performs a pendulum motion along a movement path illustrated in the times t₂ to t₆. In this case, the aerosol-generating device 100 may detect the vertical acceleration of the aerosol-generating device 100 by using the motion detector 170 and monitor changes in the vertical acceleration.

The motion detector 170 may be implemented as a combination of one or more of various sensors, such as an acceleration sensor that measures x-axis, y-axis, and z-axis acceleration values, a gyro sensor that measures angular velocity, a tilt sensor, or an inertial measurement unit (IMU).

The motion detector 170 may detect the acceleration (i.e., the vertical acceleration) of the aerosol-generating device 100 in the ground direction. The processor 130 may calculate the vertical acceleration based on the acceleration, angular velocity, inclination, orientation, etc. of various axes measured by an acceleration sensor, a gyro sensor, etc. of the motion detector 170.

The x-axis of the graph 400 indicates time(s), and the y-axis of the graph 400 indicates the vertical acceleration (g) detected by the motion detector 170. Each of the times t₁ to t₆ indicated on the x-axis of the graph 400 corresponds to the times during walking.

Until the time t₁, the user 40 holding the aerosol-generating device 100 is stationary. When the user 40 starts walking, the user 40 naturally swings his or her arms back and forth, and accordingly, the aerosol-generating device 100 performs a pendulum motion, thereby changing the vertical acceleration.

At the time t₂, the aerosol-generating device 100 reaches a highest point in the walking direction. Since the aerosol-generating device 100 is suspended momentarily when the highest point is reached, the vertical acceleration value at time t₂ becomes 0.

After the time t₂, the aerosol-generating device 100 moves in the opposite direction of the walking direction and reaches the lowest point at the time t₃. In this case, at the time t₃ when the aerosol-generating device 100 reaches the lowest point, the vertical acceleration of the aerosol-generating device 100 has a negative value.

At the time t₄, the aerosol-generating device 100 reaches the highest point in the opposite direction of the walking direction. Since the aerosol-generating device 100 is suspended momentarily when the highest point is reached, the acceleration value at the time t₄ becomes 0.

After the time t₄, the aerosol-generating device 100 moves along the walking direction and reaches a lowest point at the time t₅. At the time t₅ when the aerosol-generating device 100 reaches the lowest point, the vertical acceleration of the aerosol-generating device 100 has a positive value. The vertical acceleration having a positive or negative value may indicate the direction of movement of the aerosol-generating device 100. That is, depending on which direction is taken as a reference, the sign of the vertical acceleration may change.

The time t₆ corresponds to the same case as the time t₂. That is, at the time t₆, the aerosol-generating device 100 reaches a highest point in the walking direction. Since the aerosol-generating device 100 is suspended momentarily when the highest point is reached, the acceleration value at the time to becomes 0.

When the user 40 walks while holding the aerosol-generating device 100 in his/her hand, the motion detector 170 monitors a change the vertical acceleration from the times t₁ to t₆. That is, when the aerosol-generating device 100 is carried and moved by the user 40, the vertical acceleration of the aerosol-generating device 100 may be changed within a predetermined vertical acceleration range. Accordingly, when the vertical acceleration detected by the motion detector 170 changes within a predetermined vertical acceleration range, the processor 130 may determine that the aerosol-generating device 100 has not entered a predetermined drop state (e.g., a free drop state).

However, unlike the graph 400 of FIG. 4, when the vertical acceleration changes rapidly as it reaches a preset threshold acceleration, the aerosol-generating device 100 may be being dropped. The processor 130 monitors changes in the vertical acceleration, compares the vertical acceleration with the threshold acceleration, and determines whether the vertical acceleration has reached the threshold acceleration, thereby determining whether the device is in a drop state.

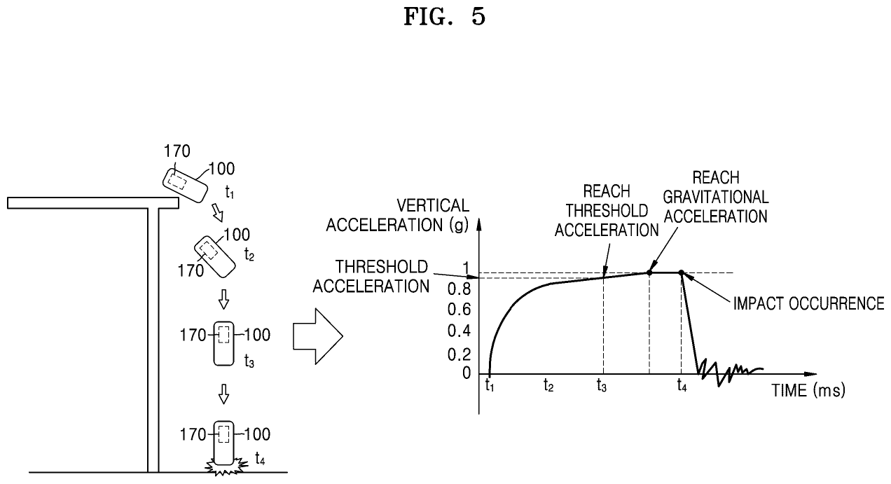

FIG. 5 is a diagram for explaining a state in which an aerosol-generating device according to an embodiment is being dropped.

Referring to FIG. 5, a situation in which the aerosol-generating device 100 is being dropped from a table to the ground is illustrated. Here, it is assumed that the motion detector 170 detects a positive vertical acceleration value when moving in the ground direction. However, the movement direction is not limited to the above, and the sign of the vertical acceleration may be set to be opposite. That is, according to the present embodiment, the sign of the vertical acceleration for an object moving in the ground direction may be set to an appropriate sign according to the design of the aerosol-generating device 100.

At the time t₁, the aerosol-generating device 100 begins to fall from an edge of the table to the ground. At the time t₁, the vertical acceleration is still 0. After the time t₁, the time t₂ is when the aerosol-generating device 100 is being freely dropped to the ground. Between the times t₁ and t₂, only gravity acts on the aerosol-generating device 100, thereby causing the vertical acceleration to rapidly increase. However, the processor 130 may not be able to accurately determine whether a change in the vertical acceleration measured by the motion detector 170 is due to a free drop or a motion caused by applying force to the aerosol-generating device 100 by the user.

At the time t₃, the aerosol-generating device 100 is in a free drop state and the vertical acceleration detected by the motion detector 170 finally reaches the threshold acceleration. In FIG. 5, for convenience of explanation, the threshold acceleration is exemplified as being equal to approximately 90% of the gravitational acceleration, but the threshold acceleration may be changed and set to other values (e.g., 100% of the gravitational acceleration, 80% of the gravitational acceleration, 70% of the gravitational acceleration, etc.).

The processor 130 determines that the aerosol-generating device 100 has entered a predetermined drop state only when it is determined that the vertical acceleration detected by the motion detector 170 has reached a threshold acceleration. Here, the predetermined drop state refers to a state in which the aerosol-generating device 100 is being freely dropped with only gravitational acceleration applied thereto without any external force. Even before the vertical acceleration of the aerosol-generating device 100 reaches the threshold acceleration, the aerosol-generating device 100 is in a free drop state, but the processor 130 may perform drop detection through comparison with the threshold acceleration to more accurately determine whether

is actually in a free drop state.

After the time t₃, the vertical acceleration of the aerosol-generating device 100 may reach the gravitational acceleration.

At the time t₄, the aerosol-generating device 100 may collide with the ground. In this case, the vertical acceleration of the aerosol-generating device 100 may change while rapidly decreasing and converging to 0. Accordingly, when the aerosol-generating device 100 is impacted due to a drop, the removable battery 110 may be separated from the aerosol-generating device 100 regardless of the user's intention or the connection of the removable battery 110 with the inside of the aerosol-generating device 100 may be disconnected.

Accordingly, the aerosol-generating device 100 according to the present embodiment may execute a protection process to preserve system data of the aerosol-generating device 100 for a period of time (e.g., a time between the times t₃ and t₄ in FIG. 5) between the detection of a predetermined drop state and the occurrence of an actual impact.

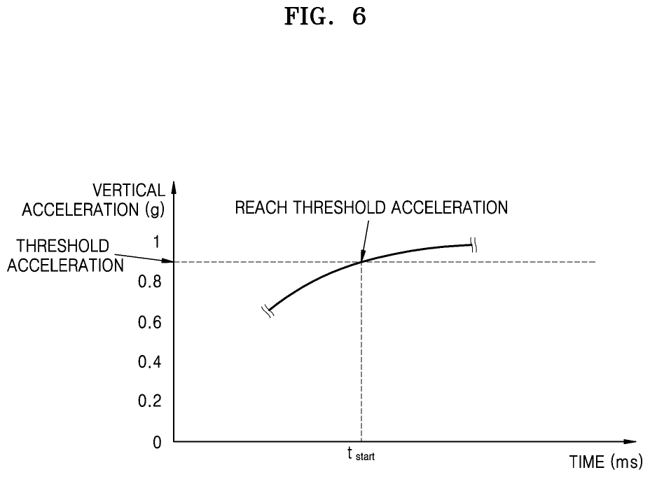

FIG. 6 is a diagram for explaining drop detection of an aerosol-generating device according to an embodiment.

Referring to FIG. 6, the aerosol-generating device 100 moves, the vertical acceleration may change accordingly, and the motion detector 170 detects the vertical acceleration. The processor 130 continuously monitors changes in the detected vertical acceleration.

The processor 130 determines that the aerosol-generating device 100 has entered a predetermined drop state when the processor 130 determines that the vertical acceleration detected by the motion detector 170 has exceeded the threshold acceleration after reaching the threshold acceleration. That is, the processor 130 may perform drop detection from a time tₛₜₐᵣₜ of FIG. 6 when the aerosol-generating device 100 enters a predetermined drop state. In FIG. 6, for convenience of explanation, the threshold acceleration is exemplified as being equal to approximately 90% of the gravitational acceleration (g) (i.e., 0.9 g), but the threshold acceleration may be changed and set to other values (e.g., 100% of the gravitational acceleration, 80% of the gravitational acceleration, 70% of the gravitational acceleration, etc.).

Meanwhile, the processor 130 may perform a protection process when it is determined that the aerosol-generating device 100 has entered a predetermined drop state.

In an example, the processor 130 may perform the protection process immediately at a time (the time

tₛₜₐᵣₜ) when it is determined that the aerosol-generating device 100 has entered a predetermined drop state.

In another example, the processor 130 may perform a protection process when the predetermined drop state is entered and the predetermined drop state is maintained for a predetermined period of time. In other words, the processor 130 may perform the protection process when a predetermined period of time (e.g., 10 ms, 50 ms, 100 ms, etc.) elapses after the time tₛₜₐᵣₜ while a predetermined drop state is maintained. This is because, although a predetermined drop state is detected, there may be cases in which the user catches the aerosol-generating device 100 before an impact occurs.

That is, the time at which the protection process is performed by the processor 130 according to the present embodiment is not limited to a single point of time, and may be variously changed according to the design of the aerosol-generating device 100.

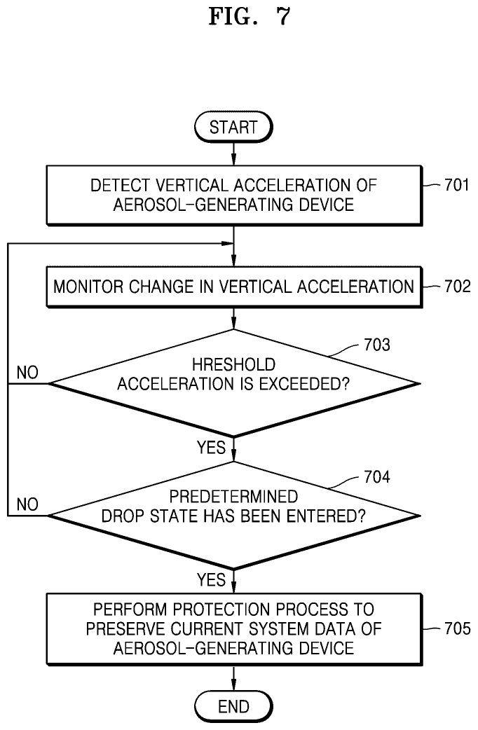

FIG. 7 is a detailed flowchart of a method of protecting an aerosol-generating device through drop detection according to an embodiment. Referring to FIG. 7, the method of protecting the aerosol-generating device 100 through drop detection corresponds to the time-series process described in the above diagrams (e.g., the aerosol-generating device 100 of FIG. 1).

In operation 701, the motion detector 170 detects the vertical acceleration of the aerosol-generating device 100. Here vertical acceleration refers to acceleration in a direction in which gravity is applied to the object, and the motion detector 170 may detect the acceleration (i.e., the vertical acceleration) of the aerosol-generating device 100 in the ground direction.

In operation 702, the processor 130 monitors changes in the detached vertical acceleration. In an example, the processor 130 may continuously monitor changes in values of the vertical acceleration. In another example, the processor 130 may monitor changes in values of the vertical acceleration at predetermined sampling periods (e.g., 5 ms, 10 ms, 100 ms, etc.). That is, the method of monitoring acceleration by the processor 130 is not limited to one method.

In operation 703, the processor 130 determines whether the detached vertical acceleration exceeds the threshold acceleration as a result of the monitoring. When the detached vertical acceleration exceeds the threshold acceleration, the drop determination of operation 703 may be performed. However, when the detected vertical acceleration exceeds threshold acceleration, the drop determination of operation 703 may be performed.

In operation 704, the processor 130 may determine whether the aerosol-generating device 100 has entered a predetermined drop state. The predetermined drop state refers to the aerosol-generating device 100 being dropped freely with only gravitational acceleration applied thereto without any external force.

In an example, the processor 130 may immediately determine that the aerosol-generating device 100 has entered a predetermined drop state when it is determined that the detected vertical acceleration has exceeded the threshold acceleration after reaching the threshold acceleration.

In another example, the processor 130 may determine that the aerosol-generating device 100 has entered a predetermined drop state when the detected vertical acceleration exceeds the threshold acceleration and remains for a predetermined period of time (e.g., 10 ms, 50 ms, 100 ms, etc.).

When it is determined that the aerosol-generating device 100 has entered a predetermined drop state, the processor 130 performs operation 705. However, when it is determined that the aerosol-generating device 100 has not entered the predetermined drop state, the processor 130 performs the acceleration monitoring of operation 702 again.

In operation 705, when it is determined that the aerosol-generating device 100 has entered a predetermined drop state, the processor 130 performs a protection process to preserve system data of the aerosol-generating device 100 before the removable battery 110 provided in the aerosol-generating device 100 is detached due to an impact. Here, the system data to be preserved includes data for controlling the heating function of the heater 120. In addition, the system data may further include usage data, etc. stored while the aerosol-generating device 100 is in use.

The processor 130 completes the performing of the protection process during a short period of time between the performing of the drop detection and the occurrence of the impact. The protection process may include, for example, resetting a currently operating system in the aerosol-generating device 100. Alternatively, the protection process may include suspending currently operating processes in the aerosol-generating device 100 and backing up system data while the currently operating processes are suspended. Alternatively, the protection process may be a combination of one or more of the processes exemplified above, or may include other processes. That is, the protection process may be a combination of one or more of the processes exemplified above, or may include other processes.

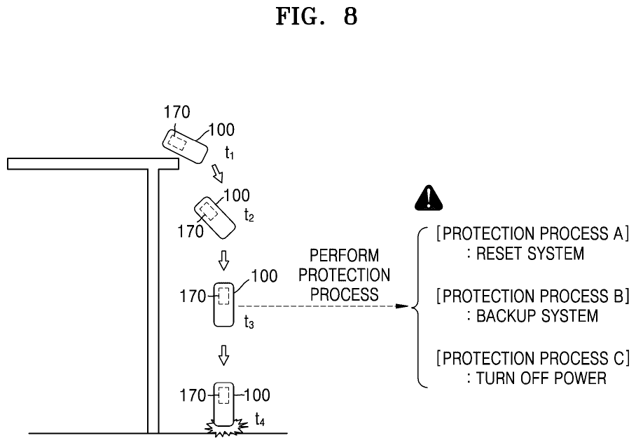

FIG. 8 is a diagram for explaining the performance of a protection process upon detecting a drop of an aerosol-generating device according to an embodiment. Referring to FIG. 8, a case in which the aerosol-generating device 100 described in FIG. 5 is being dropped will be described as an example.

The processor 130 determines that the vertical acceleration of the aerosol-generating device 100, detected by the motion detector 170, in a free drop state at the time t₃ has reached the threshold acceleration.

The processor 130 may immediately perform a protection process at the time t₃ when it is determined that the aerosol-generating device 100 has entered a predetermined drop state.

The protection process may refer to a process for preserving the system of the aerosol-generating device 100 before an impact to prevent a failure of the aerosol-generating device 100 due to battery separation caused by an impact. Here, preservation of the system may include preservation of system data including data necessary for controlling the heating operation of the heater 120 provided in the aerosol-generating device 100 and usage data stored while the aerosol-generating device 100 is in use.

The protection process may include one or more different processes. Examples of the protection process are described below.

Particularly, ‘protection process A’ may be a process for resetting a system currently operating in the aerosol-generating device 100. For example, ‘protection process A’ may refer to a reset operation to initialize the operation of the heater 120 by suspending the controlling of the heating operation of the heater 120 when the heater 120 is currently being heated. Alternatively, ‘protection process A’ may refer to a reset operation to initialize a sensing operation of various sensors provided in the aerosol-generating device 100 and a user interface display operation. That is, ‘protection process A’ may correspond to a process of initializing the system of the aerosol-generating device 100 such that the functions currently operating in the aerosol-generating device 100 do not cause errors due to a sudden power outage.

Next, ‘protection process B’ may include suspending currently operating processes in the aerosol-generating device 100 and backing up system data while the currently operating processes are suspended.

Particularly, ‘protection process B’ may be a process for maintaining the current system status and data status of the aerosol-generating device 100. For example, ‘protection process B’ may correspond to a process that instantaneously backs up, to the memory 150, system data regarding currently operating functions in the aerosol-generating device 100 and accumulated usage data, log data, etc. according to the use of the aerosol-generating device 100. That is, ‘protection process B’ may be a process of backing up data stored in the aerosol-generating device 100 to prevent system data in the aerosol-generating device 100 from being lost due to a sudden power outage. Meanwhile, when ‘protection process B’ is performed, the processor 130 may perform a restoration process for restoring the aerosol-generating device 100 to a previous system state based on backup data when the occurrence of the impact on the aerosol-generating device 100 is terminated.

‘Protection process C’ may be a process of performing a system shutdown of the aerosol-generating device 100 to turn off the power of the aerosol-generating device 100. That is, ‘protection process C’ may refer to performing a normal power-off process in advance to prevent abnormal power-off due to battery separation caused by an impact.

According to the present embodiment, the performing of the protection process by drop detection may refer to performing only one process among the protection processes A, B, and C mentioned above, or may refer to performing a combination of two or more processes among the protection processes A, B, and C. Alternatively, the performing of the protection process according to the present embodiment may include performing other processes for protecting the system of the aerosol-generating device 100 while preventing failure of the aerosol-generating device 100 due to an impact, in addition to the protection processes A, B, and C mentioned as examples.

The processor 130 may cut off the power supply from the removable battery 110 when the performance of the protection process is completed. That is, when the aerosol-generating device 100 is dropped and an impact occurs, the power supply from the removable battery 110 may be cut off so that the user may turn on the aerosol-generating device 100 after checking the damage status of the aerosol-generating device 100 or the removable battery 110.

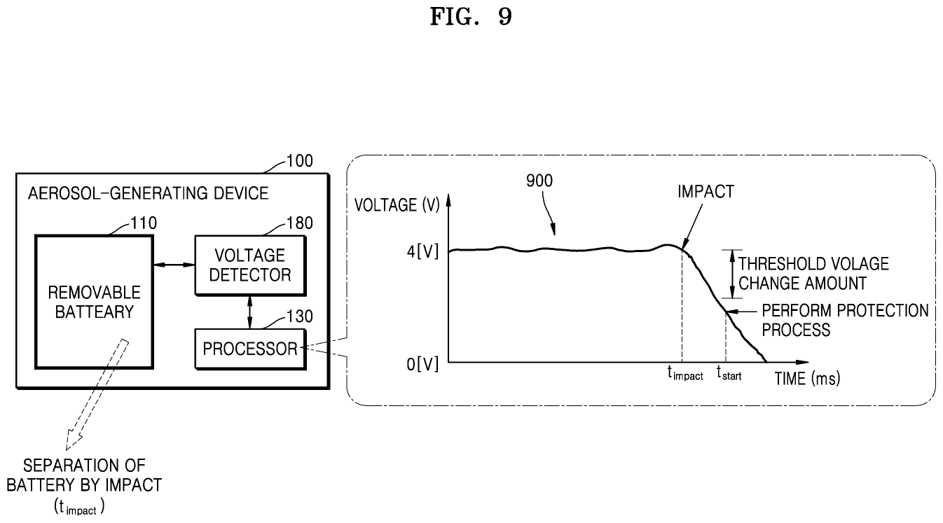

FIG. 9 is a diagram for explaining a performance of a protection process by impact detection according to an embodiment.

Referring to FIG. 9, the processor 130 may monitor changes in a voltage applied by the installed removable battery 110 using the voltage detector 180. For example, the voltage detector 180 may detect a voltage of about 3.5 [V] to about 4 [V] when the removable battery 110 is attached, and may detect a voltage of 0 [V] when the removable battery 110 is separated. Accordingly, the processor 130 may detect the connection or separation of the removable battery 110 by monitoring the change in the voltage detected by the voltage detector 180.

When the removable battery 110 is suddenly separated from the aerosol-generating device 100 due to an impact, the voltage detector 180 may detect a sudden voltage drop. That is, when a sudden voltage drop is detected and monitored by the voltage detector 180 even though the user normally removed the removable battery 110, the processor 130 may determine that an abnormal separation has occurred.

A graph 900 shows a voltage change detected by the voltage detector 180 with reference to time. The processor 130 according to the present embodiment may determine that an impact has been applied to the aerosol-generating device 100 when a sudden voltage drop exceeding the threshold voltage change occurs while monitoring the voltage change.

Particularly, when the removable battery 110 is normally mounted on the aerosol-generating device 100, the voltage detector 180 detects that a voltage of about 4 [V] is applied and maintained. However, when an impact (time t_{impact}) is applied to the aerosol-generating device 100 and the removable battery 110 is separated, the voltage detector (180) detects a sudden voltage drop from about 4 [V] to about 0 [V].

When the voltage decreases from the time when the impact is applied (the time t_{impact}) until the threshold voltage change amount is exceeded, the processor 130 may determine that the aerosol-generating device 100 has entered an impact state. Here, the threshold voltage change amount may be set to an arbitrary change amount (e.g., 1.5 [V], 2 [V], 2.3 [V], etc.) depending on the design of the aerosol-generating device 100.

In an example, the processor 130 may determine that an impact state has been entered immediately when the voltage detected by the voltage detector 180 is monitored to exceed the threshold voltage change amount.

In another example, the processor 130 may determine that an impact state has been entered only when it is monitored that the voltage does not rise again after the voltage detected by the voltage detector 180 exceeds the threshold voltage change amount and the voltage drop is maintained for a predetermined period of time (e.g., 5 ms, 10 ms, 50 ms, etc.). This is because the shock may have been applied, but the removable battery 110 may not have been completely removed and may have been reattached. That is, the impact determination method of the processor 130 is not limited to one method.

When it is determined that an impact state has been entered, the processor 130 may perform a protection process at the time tₛₜₐᵣₜ before the removable battery 110 is completely separated. Here, the processor 130 may perform the protection process described in FIG. 8 as an example.

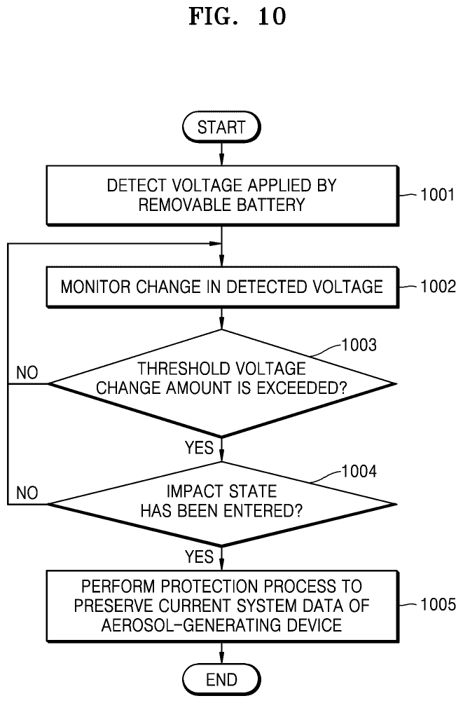

FIG. 10 is a detailed flowchart of a method of protecting an aerosol-generating device through impact detection according to an embodiment. Referring to FIG. 10, the method of protecting the aerosol-generating device 100 through impact detection corresponds to the time-series process described in the above diagrams (e.g., the aerosol-generating device 100 of FIG. 1).

In operation 1001, the voltage detector 180 detects the voltage applied by the removable battery 110. For example, when the removable battery 110 is connected to the inside of the aerosol-generating device 100, the voltage detector 180 may detect a voltage of about 3.5 [V] to about 4 [V].

In operation 1002, the processor 130 monitors changes in the detected voltage. In an example, the processor 130 may continuously monitor changes in voltage values. In another example, the processor 130 may monitor changes in voltage values at predetermined sampling periods (e.g., 5 ms, 10 ms, 100 ms, etc.). That is, the method of monitoring the voltage by the processor 130 is not limited to one method.

In operation 1003, the processor 130 determines whether the voltage change (voltage decrease) detected as a result of the monitoring exceeds a threshold voltage change amount. When the detected voltage change does not exceed the threshold voltage change amount, the voltage monitoring in operation 1002 is performed again. However, when the detected voltage change exceeds the threshold voltage change amount, the impact determination in operation 1003 may be performed.

In operation 1004, the processor 130 may determine whether the aerosol-generating device 100 has entered an impact state.

In an example, the processor 130 may immediately determine that the aerosol-generating device 100 has entered an impact state when it is determined that the detected voltage change has exceeded the threshold voltage change amount after reaching the threshold voltage change amount.

In another example, the processor 130 may determine that the aerosol-generating device 100 has entered an impact state when the voltage drop continues while the detected voltage change exceeds the threshold voltage change amount for a predetermined period of time (e.g., 10 ms, 50 ms, 100 ms, etc.). That is, the impact determination method of the processor 130 is not limited to one method.

When it is determined that the aerosol-generating device 100 has entered an impact state, the processor 130 performs operation 1005. However, when it is determined that the aerosol-generating device 100 has not entered an impact state, the processor 130 performs the voltage monitoring of operation 1002 again.

In operation 1005, when it is determined that the aerosol-generating device 100 has entered an impact state, the processor 130 performs a protection process to preserve system data of the aerosol-generating device 100 before the removable battery 110 provided in the aerosol-generating device 100 is detached due to an impact.

The processor 130 completes the performing of the protection process during a short period of time between the performing of the impact detection and the occurrence of the impact. The protection process may include, for example, resetting a currently operating system in the aerosol-generating device 100. Alternatively, the protection process may include suspending currently operating processes in the aerosol-generating device 100 and backing up system data while the currently operating processes are suspended. Alternatively, the protection process may be a combination of one or more of the processes exemplified above, or may include other processes. That is, the protection process may be a combination of one or more of the processes exemplified above, or may include other processes.

Meanwhile, in FIGS. 9 and 10, the impact detection for the aerosol-generating device 100 is performed based on a change in the voltage detected by the voltage detector 180. However, the aerosol-generating device 100 according to the present embodiment may perform impact detection using a method other than voltage detection by the voltage detector 180. For example, the impact detection method may also be used, the method in which a sheet-type detection sensor capable of detecting external pressure is installed in an aerosol-generating device 100 and an impact is determined to have occurred when a change in external pressure exceeding a predetermined threshold value is detected.

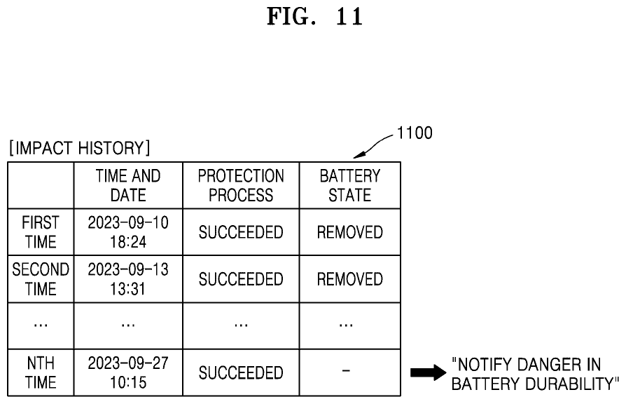

FIG. 11 is a diagram for explaining an impact history of impacts occurred in an aerosol-generating device according to an embodiment.

Referring to FIG. 11, the processor 130 may manage impact history information 1100 regarding impacts that occurred in the aerosol-generating device 100. For example, the impact history information 1100 may include information about the number of times the impact occurred, the time and date of the impact occurrence, whether the protection process was performed, whether the battery was separated, etc. The impact history information 1100 may be updated while being stored in memory 150.

In the impact history information 1100, the number of times the impact occurred may represent the number of drop detection exceeding the threshold acceleration or the number of impact detection exceeding the threshold voltage change amount. When the aerosol-generating device 100 or the removable battery 110 is repeatedly impacted, the aerosol-generating device 100 or the removable battery 110 may malfunction. Particularly, the removable battery 110 is a component that is easily damaged due to reduced durability caused by repeated impact. Therefore, when the removable battery 110 is subjected to a great number of impacts, battery replacement may be desirable.

Accordingly, the processor 130 may manage the impact history information 1100 and perform control to notify the user of a risk to battery durability when the number of impacts reaches a certain number of times (e.g., n times). For example, the processor 130 may control a battery replacement notification to be provided through the user interface 140.

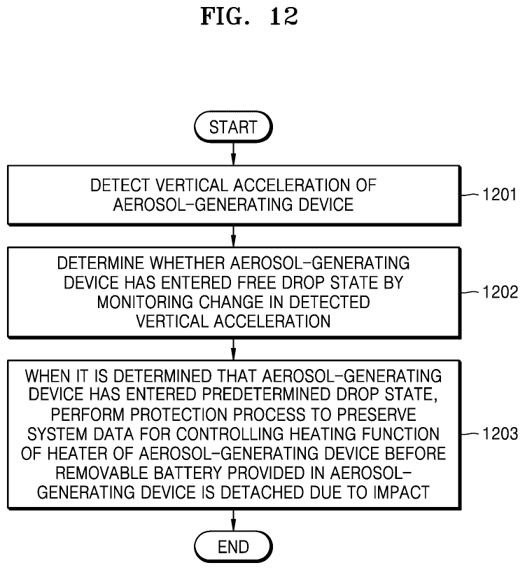

FIG. 12 is a flowchart of a method of protecting an aerosol-generating device through drop detection according to an embodiment. The method of FIG. 12 corresponds to the operations performed in time series in the diagrams described above. Therefore, even when the contents are omitted below, the contents described in the diagrams above may also be applied to the method of FIG. 12.

In operation 1201, the motion detector 170 detects the vertical acceleration of the aerosol-generating device 100.

In operation 1202, the processor 130 determines whether the aerosol-generating device 100 has entered a predetermined drop state by monitoring a change in the detected vertical acceleration.

In operation 1203, when it is determined that the aerosol-generating device 100 has entered a predetermined drop state, the processor 130 performs a protection process to preserve system data for controlling the heating function of the heater of the aerosol-generating device 100 before the removable battery 110 provided in the aerosol-generating device 100 is detached due to an impact.

The method described above may be composed as a program that is executable by a computer and may be implemented by a general-purpose digital computer for operating the program by using a non-transitory computer-readable recording medium. Also, a data structure used in the method described above may be recorded on the computer-readable recording medium by using various elements. The computer-readable recording medium includes a storage medium, such as a magnetic storage medium (for example, ROM, RAM, USB, a floppy disk, a hard disk, etc.) and an optical reading medium (for example, a CD-ROM, a DVD, etc.)

One of ordinary skill in the art pertaining to the present embodiments can understand that various changes in form and details can be made therein without departing from the scope of the characteristics described above. The disclosed methods should be considered in a descriptive sense only and not for purposes of limitation. The scope of the present embodiments is not reflected in the descriptions above and is reflected in the claims, and all differences within the equivalent scope shall be interpreted to be included in the present embodiments.

1. An aerosol-generating device comprising:
a motion detector configured to detect a vertical acceleration of the aerosol-generating device; and
a processor configured to determine whether the aerosol-generating device has entered a predetermined drop state by monitoring a change in the detected vertical acceleration, wherein
the processor is further configured to,
when it is determined that the aerosol-generating device has entered the predetermined drop state, perform a protection process to preserve system data for controlling a heating function of a heater of the aerosol-generating device before a removable battery provided in the aerosol-generating device is detached due to an impact.

2. The aerosol-generating device of claim 1, wherein the processor is further configured to, when it is monitored that the detected vertical acceleration exceeds a threshold acceleration, determine that the aerosol-generating device has entered the predetermined drop state.

3. The aerosol-generating device of claim 2, wherein
the threshold acceleration is set as a value corresponding to a predetermined ratio of a gravitational acceleration, and
the predetermined drop state corresponds to a free drop state of the aerosol-generating device.

4. The aerosol-generating device of claim 2, wherein the processor is further configured to, when the predetermined free drop state is maintained for a predetermined period of time after being entered, perform the protection process.

5. The aerosol-generating device of claim 1, wherein the protection process comprises resetting a currently operating system in the aerosol-generating device.

6. The aerosol-generating device of claim 1, wherein the protection process comprises suspending currently operating processes in the aerosol-generating device and backing up the system data while the currently operating processes are suspended.

7. The aerosol-generating device of claim 6, wherein the system data comprises data necessary for controlling a heating operation of the heater provided in the aerosol-generating device and data stored while the aerosol-generating device is in use.

8. The aerosol-generating device of claim 1, wherein the processor is further configured to, when the protection process is completed, cut off power supply from the removable battery.

9. The aerosol-generating device of claim 1, wherein the processor is further configured to, when an occurrence of the impact on the aerosol-generating device is terminated, perform a restoration process to restore the aerosol-generating device to a previous system state.

10. The aerosol-generating device of claim 1, wherein the processor is further configured to, when the impact occurred on the aerosol-generating device, store an impact history.

11. A method of protecting an aerosol-generating device by using drop detection, the method comprising:
detecting a vertical acceleration of the aerosol-generating device by using a motion detector;
determining, by using a processor, whether the aerosol-generating device has entered a predetermined drop state by monitoring a change in the detected vertical acceleration; and
when it is determined that the aerosol-generating device has entered the predetermined drop state, performing, by using the processor, a protection process to preserve system data for controlling a heating function of a heater of the aerosol-generating device before a removable battery provided in the aerosol-generating device is detached due to an impact.

12. The method of claim 11, wherein the determining comprises, when it is monitored that the detected vertical acceleration exceeds a threshold acceleration, determining that the aerosol-generating device has entered the predetermined drop state.

13. The method of claim 11, wherein
the threshold acceleration is set as a value of a predetermined ratio of a gravitational acceleration, and
the predetermined drop state corresponds to a free drop state of the aerosol-generating device.

14. The method of claim 11, wherein the protection process comprises at least one of a process of resetting a currently operating system in the aerosol-generating device and a process of suspending currently operating processes in the aerosol-generating device to back up the system data while the currently operating processes are suspended.

15. The method of claim 11, further comprising, when an occurrence of the impact on the aerosol-generating device is terminated, performing a restoration process to restore the aerosol-generating device to a previous system state.
